(19) United States
(12) Patent Application Publication
(10) Pub. No.: US 2003/0167107 A1
(43) Pub. Date: Sep. 4, 2003

(54) Method for placing the wheels of a trailer in the wheel tracks left by a tractor vehicle, and device for implementing this method

(75) Inventors: Alain Guesdon, Noisy Sur Ecole (FR); Jean-Michel Le Bars, Paron (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: KUHN-NODET S.A., MONTEREAU (FR)

(21) Appl. No.: 10/325,938

(22) Filed: Dec. 23, 2002

(30) Foreign Application Priority Data
Jan. 10, 2002 (FR) 02 00340

(51) Int. Cl. G05D 1/00

(52) U.S. Cl. 701/1

(57) ABSTRACT

The present invention relates to a method for placing the wheels of a trailer in the wheeltracks left by the wheels of a tractor vehicle. The trailer comprises steering elements intended to alter the path of the trailer, a means for determining the appropriate orientation to be given to the steering elements, and an actuator intended to act on the steering elements. This method is one which comprises the following steps:

the history of a parameter representative of the path of the tractor vehicle is established so as to be able to find the value that the parameter had at a given moment;

the relevant moment to be consulted in the history is determined;

the value that the parameter had at the relevant moment is used to orientate the steering elements.

This method applies in particular to agricultural sprayers.

### BACKGROUND OF THE INVENTION

1. Field of the Invention

The present invention relates to a method for placing the wheels of a trailer in the wheeltracks of a tractor vehicle, said trailer comprising a means intended to detect the path taken by said tractor vehicle, steering elements intended to alter the path of said trailer, a means for determining the appropriate orientation to be given to said steering elements, and an actuator intended to act on said steering elements.

2. Discussion of the Background

When an agricultural sprayer of the trailed type is used, it is desirable for the wheels of said sprayer to run precisely in the wheeltracks of the tractor vehicle. The amount of crop crushed by the passage of such a coupled assembly is thus reduced to the strict minimum.

While this arrangement of the wheels of the sprayer in the tracks left by the wheels of the tractor vehicle is easy to achieve when the coupled assembly is traveling in a straight line, the same is no longer true, however, when the coupled assembly takes a curve. What happens is that the wheels of a conventional trailed sprayer naturally have a tendency to cut the corner taken by the tractor vehicle.

To lessen this phenomenon, it is known practice in the prior art for trailed sprayers to be equipped with a steering device.

Indeed, document EP 1 088 743 describes an agricultural sprayer trailer coupled to a tractor vehicle, said trailer being fitted with orientable wheels. Said orientable wheels are connected together so as to form a steered axle intended to alter the path of said trailer. Said steered axle is actuated by a ram. To determine the orientation to be given to said orientable wheels, this known trailer also comprises a cam, a slider and two position sensors. Said cam, mounted to pivot on said trailer, is connected by a cable to said tractor vehicle. Thus, each change in direction of said tractor vehicle causes, via said cable, said cam to pivot. In turn, the pivoting of said cam causes a movement of said slider along a bar of said steered axle. Said position sensors are intended to inform an analogue computer of the movements of said slider. Thus informed of the orientation to be given to said orientable wheels, said analogue computer operates a distributor supplying said ram accordingly.

While admittedly this trailer does position itself better than conventional trailers in the wheeltracks of said tractor vehicle it does, however, have drawbacks.

Indeed, with the trailer of document EP 1 088 743, actuation of said ram is forbidden for a predetermined period of time. This period of time begins at the instant the tractor vehicle begins to turn with respect to said trailer. Actuation of said ram is permitted only when the wheels of said trailer have reached the position that the rear wheels of said tractor vehicle occupied when the latter began to turn with respect to said trailer. Over the portion covered during said predetermined period of time, this known trailer therefore behaves like a conventional trailer. In consequence, at least in said portion, the wheels of this known trailer have a tendency to leave the tracks left by the wheels of the tractor vehicle. This space between the path of said trailer and the path of said tractor vehicle is encountered when entering and when leaving a curve. In addition, this space in the path may become significant in curves with a small radius of curvature.

Furthermore, at the end of said predetermined period of time, said ram is actuated to orientate the wheels of said trailer according to the last position occupied by said slider. Thus, when two changes in direction occur over a period of time shorter than said predetermined period of time, only the second direction change is taken into consideration. In consequence, at least over the portion corresponding to the first change in direction, the wheels of this known trailer tend to leave the tracks left by the wheels of the tractor vehicle. Such a situation may be encountered when relatively closely spaced curves are strung together, as for example in an S-curve.

For its part, document EP 1 081 020 describes an agricultural trailer coupled to a tractor vehicle by means of a drawbar. Said drawbar is connected to the chassis of said trailer by means of an articulation, the axis of which is directed upward. A ram is also provided so as to pivot said drawbar about said articulation. Said drawbar thus constitutes a steering drawbar intended to alter the path of said trailer. This known trailer additionally comprises a microprocessor connected to various sensors. Among these sensors there is, in particular, provided a gyroscope for determining the radius of curvature of the path followed by said tractor vehicle. Depending on said radius of curvature, said microprocessor calculates a target value corresponding to the orientation that said steering drawbar ought to have in order to place the wheels of said trailer in the tracks of the rear wheels of the said tractor vehicle. In order to keep the wheels of said trailer in the wheeltracks of said tractor vehicle also during phases of entering and leaving the curve, said microprocessor additionally, using a transition law, defines the way of bringing said steering drawbar into the position defined by said target value. Finally, the ram of said steering drawbar is driven in accordance with said transition law.

This known trailer can also be better positioned in the wheeltracks of said tractor vehicle than conventional trailers. However, it too has drawbacks.

What happens is that the microprocessor breaks the route used by said tractor vehicle down into successive portions. The length of each portion corresponds to the distance separating the rear wheels of said tractor vehicle and the axle of said trailer. For each portion, said microprocessor calculates a target value and a corresponding transition law. Said transition law is calculated in such a way that, at the end of said portion, said steering drawbar is orientated according to said target value. As a result, in order to calculate said target value, the microprocessor takes into consideration the radius of curvature measured at the start of the portion. In addition, to calculate the transition law, said microprocessor considers that the route used by said tractor vehicle has a radius of curvature that remains constant over the entire portion. In consequence, when there are two changes in direction on one and the same portion, this time only the first change in direction is taken into consideration. Thus, as in document EP 1 088 743, the trailer in document EP 1 081 020 is not able to take two closely spaced direction changes into consideration.

Furthermore, the method described in document EP 1 081 020 to determine the transition law is relatively complicated to perform. Indeed, each transition law requires preliminary calculations of numerous coefficients. As such calculations need to be performed quickly, this control method requires a relatively powerful microprocessor.

The steering devices of the prior art are therefore incapable of taking two closely spaced direction changes of said tractor vehicle into consideration. In addition, the known steering devices do not in a simple and adequate way manage the phases of entering and leaving curves.

### SUMMARY OF THE INVENTION

The object of the present invention is to overcome these drawbacks of the prior art.

To this end, the method according to the present invention is one which comprises the following steps:

the history of a parameter representative of the path of said tractor vehicle is established so as to be able to find the value that said parameter had at a given moment;

the relevant moment to be consulted in said history is determined;

the value that said parameter had at said relevant moment is used to orientate said steering elements.

Thus, with the method according to the present invention, all the changes in direction, even closely spaced ones, of said tractor vehicle are taken into consideration.

According to another feature of the present invention, the value used for orientating said steering elements advantageously corresponds to the value that said parameter had when the rear wheels of said tractor vehicle occupied the position now occupied by the wheels of said trailer.

According to another feature of the present invention and in a particularly advantageous way, in order to orientate said steering elements use is made also of the current value of said parameter in addition to said past value. Said trailer thus reacts immediately to any change in direction of said tractor vehicle. During the phases of entering and leaving curves, the wheels of said trailer thus remain positioned in the wheeltracks of said tractor vehicle.

The present invention also relates to a device for implementing this method, said device comprising a sensor intended to detect the path followed by a tractor vehicle, an actuator intended to act on the steering elements of a trailer, and a means for controlling said actuator. Said device is one which additionally comprises an electronic circuit comprising several memory cells intended to store the change over time of a parameter representative of the path of said tractor vehicle.

The present invention also relates to a coupled assembly made up of a tractor vehicle and of a trailer equipped with a device as described herein above.

### BRIEF DESCRIPTION OF THE DRAWINGS

Other features of the invention, to be considered separately or in all feasible combinations thereof, will become further apparent in the following description of nonlimiting exemplary embodiments of the invention which are depicted in the appended drawings in which:

FIG. 1 schematically depicts an example of a coupled assembly according to the present invention,

FIGS. 2, 3, 4 and 5 schematically depict the content of the memory cells of an electronic circuit at various moments T.

### DESCRIPTION OF THE PREFERRED EMBODIMENT

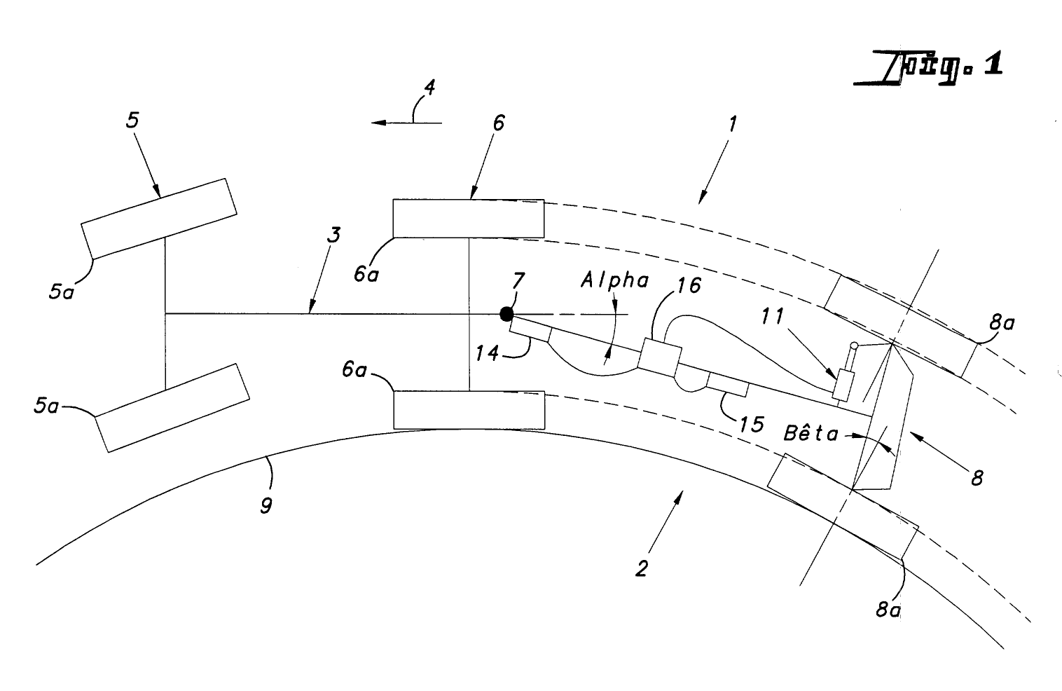

FIG. 1 depicts, schematically and in a view from above, a coupled assembly 1 traveling in a curve 9. Said coupled assembly 1 is made up of a trailer 2 and of a tractor vehicle 3. Said tractor vehicle 3 pulls said trailer 2 in a direction and sense of forward travel indicated by the arrow 4. In the remainder of the description, the ideas of “front” and “rear”, “in front of” and “behind” are defined with respect to the direction of forward travel and the ideas of “right” and “left” are defined viewing said coupled assembly 1 from the rear in the direction of forward travel 4.

In general, said tractor vehicle 3 has a front axle 5 and a rear axle 6. The wheels 5a of said front axle 5 are advantageously steering-wheels. For its part, said trailer 2 has an axle 8 equipped with wheels 8a. In addition, said trailer 2 is connected to the rear of said tractor vehicle 3 at a hitching point 7.

FIG. 1 more specifically depicts an example of a coupled assembly 1 in which said trailer 2 comprises a steering device according to the present invention. Thus, the wheels 8a of said trailer 2 advantageously run in the tracks (depicted in dotted line) left by the wheels 6a of the rear axle 6 of said tractor vehicle 3.

To achieve this and in the light of FIG. 1, said steering device comprises steering elements intended to alter the path of said trailer 2. Said steering elements are advantageously produced by means of a steering axle 8. The wheels 8a of said trailer 2 can thus pivot through an angle (Beta) about an upwardly-directed respective axis. Such a steering axle 8 is known to the person skilled in the art and will therefore not be described any further.

Said steering device also comprises a means intended to detect the path taken by said tractor vehicle 3. In the exemplary embodiment depicted in FIG. 1, said means is made up of an angle sensor 14 and of a speed sensor 15. Said angle sensor 14, arranged at said hitching point 7, measures an angle (Alpha) between a longitudinal axis of said tractor vehicle 3 and a longitudinal axis of said trailer 2. For its part, said speed sensor 15 determines the speed of forward travel V of said coupled assembly 1. Such a speed sensor 15 is produced, for example, using a radar connected to said trailer 2.

Said steering device finally comprises a means for determining the appropriate orientation to be given to said wheels 8a and for maneuvering these wheels accordingly. In the exemplary embodiment depicted in FIG. 1, this means is produced using a microprocessor 16 controlling a ram 11. Said ram 11 is advantageously arranged in such a way as to act on the orientation of said wheels 8a.

According to the present invention, in order to place the wheels 8a of said trailer 2 in the wheeltracks left by the wheels 6a of said tractor vehicle 3, the procedure is as follows.

The history of a parameter representative of the path of said tractor vehicle 3 is established. As a result, it will be possible to find the value that said parameter had at a given moment. Next, the relevant moment to be consulted in said history is determined. Finally, the value that said parameter had at said relevant moment is used to orientate said steering elements.

As a preference, the value used for orientating said steering elements corresponds to the value that said parameter had when the rear wheels 6a of said tractor vehicle 3 occupied the position now occupied by the wheels 8a of said trailer 2.

In a way which is particularly advantageous for orientating said steering elements, use is also made of the current value of said parameter in addition to said past value. Said trailer 2 therefore reacts immediately to any change in direction of said tractor vehicle 3. During the phases of entering and leaving curves, the wheels 8a of said trailer 2 thus remain positioned in the wheeltracks 6a of said tractor vehicle 3.

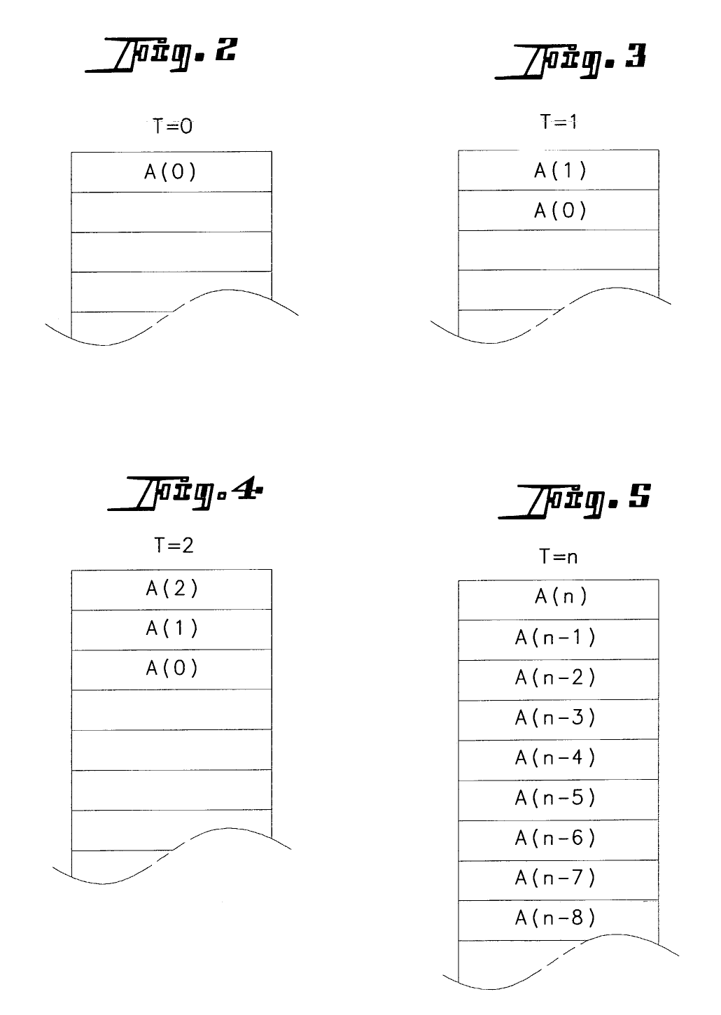

In the exemplary embodiment depicted in the figures, in order to implement the method said steering device additionally comprises an electronic circuit equipped with several memory cells. Said electronic circuit is intended to store the history of a parameter representative of the path of said tractor vehicle 3. Said angle (Alpha) for example constitutes such a representative parameter. In the light of FIGS. 2 to 5, said electronic circuit can be depicted symbolically in the form of a single-column table. Each cell of said table corresponds to one of said memory cells. As a preference, said electronic circuit is integrated into said microprocessor 16.

In the exemplary embodiment depicted in the figures, the method according to the present invention is implemented as follows.

At regular time intervals, said microprocessor 16 feeds said electronic circuit with the value A of the angle (Alpha) supplied by said angle sensor 14. Thus, more specifically, and in the light of FIG. 2, at a moment T=0 said microprocessor 16 writes the current value A{0} of said angle (Alpha) to the first memory cell. Then, at a moment T=1, the value A{0} initially written to the first memory cell is advantageously transmitted to the second memory cell. In addition, said microprocessor 16 writes the current value A{1} of said angle (Alpha) to said first memory cell thus emptied. The status of said electronic circuit at the moment T=1 has been depicted in FIG. 3. Next, at moment T=2 and in the light of FIG. 4, the values A{0} and A{1} are advantageously shifted by one memory cell respectively. Said microprocessor 16 writes the current value A{2} of said angle (Alpha) to said first memory cell which has once again become empty. At the moment T=2, the first three memory cells of said electronic circuit therefore contain, in order, the values A{2}, A{1} and A{0}. Generalizing, and in the light of FIG. 5, at the moment T=n, the memory cells of said electronic circuit contain, respectively, the values A{n}, A{n−1}, A{n−2}, A{n−3}, etc.

As a preference, the time interval separating two successive moments T is very much shorter than the time that might separate two changes in direction of said tractor vehicle 3. As a result, all the changes in direction of said tractor vehicle 3, even though as close together as can be, are taken into consideration by said steering device.

By way of example for a coupled assembly 1 made up of an agricultural tractor and of a trailed sprayer, the time interval of the order of one tenth of a second makes it possible to obtain a good result. As a result, if the value A{n} corresponds to the current value of said angle (Alpha), the value A{n−1} then corresponds to the value that said angle (Alpha) had 0.1 second ago. For its part, the value A{n−2} corresponds then to the value that said angle (Alpha) had 0.2 second beforehand. The same is true for all the values contained in said memory cells.

In order to determine the relevant moment to be consulted in the history thus established, said microprocessor 16 calculates a lag datum R dependent on said speed of forward travel V of said coupled assembly 1. Said lag datum R corresponds advantageously to the time taken by said coupled assembly 1 to cover a distance equivalent to the distance separating the axle 8 of said trailer 2 from the rear axle 6 of said tractor vehicle 3. Said relevant moment to be consulted corresponds to the present moment retarded by said lag datum R.

By way of example, in the case of a coupled assembly 1 traveling at 2.5 m/s (namely 9 km/h) and in which the distance separating the axle 8 of said trailer 2 and the rear axle 6 of said tractor vehicle 3 is equal to 5 meters, said lag datum R has the value 2 seconds. Thus, with said time interval of the order of one tenth of a second, the value to be used to orientate the wheels 8a of said trailer 2 is the value A{n−20}.

As a preference, said lag datum R is updated at the same rate as said electronic circuit. Thus, at the moment T=n, said microprocessor 16 calculates a lag datum R{n} dependent on the instantaneous speed of forward travel V{n} of said coupled assembly 1.

In a way which is also preferred, said lag datum R{n} is rounded up to an integer multiple of the time interval used to establish said history. As a result, at the moment T=n, the value to be used to orientate the wheels 8a of said trailer 2 is the value A{n−R{n}}.

To determine the orientation to be given to the wheels 8a of said trailer 2, said microprocessor 16 calculates a value M on the basis of said value A{n−R{n}} and of said value A{n}. Said value M thus also takes the current value of said angle (Alpha) into consideration. As a result, said trailer 2 reacts immediately to any change in direction of said tractor vehicle 3. During phases of entering and leaving curves, the wheels 8a of said trailer 2 therefore remain positioned in the wheeltracks of the wheels 6a of said tractor vehicle 3.

As a preference, said value M is also updated with the same time interval as said electronic circuit. Thus, at the moment T=n, said microprocessor 16 calculates a value M{n}.

Also as a preference, said value M{n} is a weighted mean of values A{n} and A{n−R{n}}, that is to say:

M{n}=C×A{n}+(1−C)×A{n−R{n}}

The weighting coefficient C is advantageously adjustable so as to be able, if necessary, to tailor said steering device to said coupled assembly 1. As the earlier value A{n−R{n}} is of greater significance in calculating M{n}, said weighting coefficient C is preferably between 1% and 49%.

The value of the angle (Beta) to be given to the wheels 8a of said trailer 2 is finally determined from said value M{n} and by means of a conversion table. Said microprocessor 16 then controls said ram 11 to orientate said wheels 8a accordingly.

The steering device thus described therefore makes it possible, every tenth of a second, to adjust the orientation of the wheels 8a of said trailer 2 according to the change in path of said tractor vehicle 3.

Said method and said steering device of the present invention apply particularly to agricultural sprayers.

The coupled assembly 1 which has just been described is merely one example of an embodiment and of a use which must not in any way be considered to limit the field of protection defined by the claims which follow.

What is claimed as new and desired to be secured by Letters Patent of the United States is:

1. A method for placing the wheels of a trailer in the wheeltracks left by the rear wheels of a tractor vehicle, said trailer comprising a means intended to detect a path taken by said tractor vehicle, steering elements intended to alter a path of said trailer, a means for determining an appropriate orientation to be given to said steering elements, and an actuator intended to act on said steering elements, which method comprises the following steps:
a history of a parameter representative of the path of said tractor vehicle is established so as to be able to find a value that said parameter had at a given moment;
a relevant moment to be consulted in said history is determined;
a value that said parameter had at said relevant moment is used to orientate said steering elements.

2. Method as claimed in claim 1, wherein said value used for orientating said steering elements corresponds to a value that said parameter had when the rear wheels of said tractor vehicle occupied a position now occupied by the wheels of said trailer.

3. Method as claimed in claim 2, wherein, in order to orientate said steering elements, consideration is also given to a current value of said parameter in addition to the value that said parameter had when the rear wheels of said tractor vehicle occupied the position now occupied by the wheels of said trailer.

4. A device for implementing the method as claimed in claim 1, said device comprising a means intended to detect a path taken by a tractor vehicle, steering elements intended to alter a path of a trailer, a means for determining an appropriate orientation to be given to said steering elements, and an actuator intended to act on said steering elements, and which device additionally comprises an electronic circuit intended to store a history of a parameter representative of the path of said tractor vehicle.

5. Device as claimed in claim 4, wherein said electronic circuit is updated at regular time intervals, said time interval being of an order of one tenth of a second.

6. Device as claimed in claim 4 and which comprises a means for calculating a lag datum R depending on a speed of forward travel V of said tractor vehicle.

7. Device as claimed in claim 6, wherein a value of said lag datum R corresponds to a time taken by said tractor vehicle to cover a distance equivalent to a distance separating an axle of said trailer from a rear axle of said tractor vehicle.

8. Device as claimed in claim 6, wherein said lag datum R is updated at regular time intervals, said time interval being of the order of one tenth of a second.

9. Device as claimed in claim 4, and which additionally comprises a means for calculating a weighted mean M of a current value with an earlier value of said parameter representative of the path of said tractor vehicle, said current value being allocated a weighting coefficient C and said earlier value being allocated a weighting coefficient (1−C).

10. Device as claimed in claim 9, wherein said weighting coefficient C is adjustable.

11. Device as claimed in claim 9 or 10, wherein said weighting coefficient C is between 0.01 and 0.49.

12. Device as claimed in claim 9, wherein said weighted mean M is updated at regular time intervals, said time interval being of the order of one tenth of a second.

13. Device as claimed in claim 4, wherein said trailer is an agricultural sprayer.
